(19) United States
(12) Patent Application Publication
(10) Pub. No.: US 2024/0086455 A1
(43) Pub. Date: Mar. 14, 2024

(54) IMAGE SEARCH APPARATUS, IMAGE SEARCH METHOD, AND NON-TRANSITORY STORAGE MEDIUM

(71) Applicant: NEC Corporation, Tokyo (JP)

(72) Inventors: Tingting Dong, Tokyo (JP); Noboru YOSHIDA, Tokyo (JP)

(73) Assignee: NEC Corporation, Tokyo (JP)

(21) Appl. No.: 18/240,519

(22) Filed: Aug. 31, 2023

(30) Foreign Application Priority Data
Sep. 8, 2022 (JP) 2022-142740

(51) Int. Cl. G06F 16/535

(52) U.S. Cl. CPC G06F 16/535

(57) ABSTRACT

To improve accuracy of processing of searching for an image including a desired person from among a plurality of images, the present invention provides an image search apparatus 10 including an image acquisition unit 11 that acquires a plurality of query images, an attribute information generation unit 12 that generates attribute information from each of a plurality of the query images, an integration unit 13 that generates integrated attribute information by integrating a plurality of pieces of the attribute information generated from each of a plurality of the query images, and a search unit 14 that searches for a target image from a plurality of reference images by using the integrated attribute information.

This application is based upon and claims the benefit of priority from Japanese patent application No. 2022-142740, filed on Sep. 8, 2022, the disclosure of which is incorporated herein in its entirety by reference.

### TECHNICAL FIELD

The present invention relates to an image search apparatus, an image search method, and a program.

### BACKGROUND ART

A technique associated with the present invention is disclosed in Patent Document 1 (International Patent Publication No. WO2018/159095), Patent Document 2 (International Patent Publication No. WO2016/035632), Patent Document 3 (International Patent Publication No. WO2021/229751), and Patent Document 4 (Japanese Patent Application Publication (Translation of PCT Application) No. 2016-504656).
Patent Document 1 discloses processing of generating a first query, based on a user input, searching for an image, based on the first query, presuming a relation between a plurality of images selected by a predetermined operation from among images hit by the search, generating a second query, based on the presumed relation, and searching for an image, based on the second query.
Patent Document 2 discloses processing of complementing attribute information determined by an image analysis, and attribute information input by a user, each other.
Patent Document 3 discloses processing of performing an image search by using a database in which attribute information of each of images serving as a search target is stored.
Patent Document 4 discloses a technique of computing an attribute score indicating reliability of an attribute, and performing an image search, based on the attribute score.

### DISCLOSURE OF THE INVENTION

It becomes possible to search for a desired image (an image including a target person) with high accuracy by performing an image search with use of attribute information (such as gender, age, clothes, and a pose of a target person) of a wide variety.

By the way, as one example of an image search, a search using one query image is proposed. In a case of this example, it is possible to search for a desired target image with high accuracy by performing the image search with use of one query image in which all pieces of attribute information of a wide variety become a desired content. However, a lot of effort is required to search for one query image in which all pieces of attribute information of a wide variety become a desired content. Further, in a case where the image search is performed by using one query image in which some pieces of attribute information of a wide variety become a desired content, but other pieces of the attribute information do not become the desired content, accuracy of searching for a desired target image is lowered. None of Patent Documents 1 to 4 discloses the problem and a solving means thereof.

One example of an object of the present invention is, in view of the above-described problem, to provide an image search apparatus, an image search method, and a program for achieving a task of improving accuracy of processing of searching for a desired image from among a plurality of images.

One aspect of the present invention provides an image search apparatus including:
an image acquisition unit that acquires a plurality of query images;
an attribute information generation unit that generates attribute information from each of a plurality of the query images;
an integration unit that generates integrated attribute information by integrating a plurality of pieces of the attribute information generated from each of a plurality of the query images; and
a search unit that searches for a target image from among a plurality of reference images by using the integrated attribute information.

One aspect of the present invention provides an image search method including,
by one or more computers:
acquiring a plurality of query images;
generating attribute information from each of a plurality of the query images;
generating integrated attribute information by integrating a plurality of pieces of the attribute information generated from each of a plurality of the query images; and
searching for a target image from among a plurality of reference images by using the integrated attribute information.

One aspect of the present invention provides a program causing a computer to function as:
an image acquisition unit that acquires a plurality of query images;
an attribute information generation unit that generates attribute information from each of a plurality of the query images;
an integration unit that generates integrated attribute information by integrating a plurality of pieces of the attribute information generated from each of a plurality of the query images; and
a search unit that searches for a target image from among a plurality of reference images by using the integrated attribute information.

One aspect of the present invention achieves an image search apparatus, an image search method, and a program for achieving a task of improving accuracy of processing of searching for a desired image from among a plurality of images.

### BRIEF DESCRIPTION OF THE DRAWINGS

The above-described object, other objects, features, and advantages will become more apparent from suitable example embodiments described below and the following accompanying drawings.

FIG. 1 is a diagram illustrating one example of a functional block diagram of an image search apparatus.

FIG. 2 is a diagram illustrating an overview of processing of the image search apparatus.

FIG. 3 is a diagram illustrating one example of a hardware configuration of the image search apparatus.

FIG. 4 is a diagram illustrating one example of an integration method.

FIG. 5 is a diagram schematically illustrating one example of information to be processed by the image search apparatus.

FIG. 6 is a diagram illustrating one example of the integration method.

FIG. 7 is a diagram illustrating one example of the integration method.

FIG. 8 is a diagram illustrating one example of the integration method.

FIG. 9 is a diagram illustrating one example of the integration method.

FIG. 10 is a diagram illustrating one example of processing of accepting an input of specifying a portion of a body of a person.

FIG. 11 is a diagram schematically illustrating another example of information to be processed by the image search apparatus.

FIG. 12 is a flowchart illustrating one example of a flow of processing of the image search apparatus.

FIG. 13 is a diagram illustrating another example of a functional block diagram of the image search apparatus.

FIG. 14 is a flowchart illustrating another example of a flow of processing of the image search apparatus.

FIG. 15 is a flowchart illustrating another example of a flow of processing of the image search apparatus.

### DESCRIPTION OF EMBODIMENTS

Hereinafter, example embodiments according to the present invention are described by using the drawings. Note that, in all drawings, a similar constituent element is indicated by a similar reference sign, and description thereof is omitted as necessary.

### First Example Embodiment

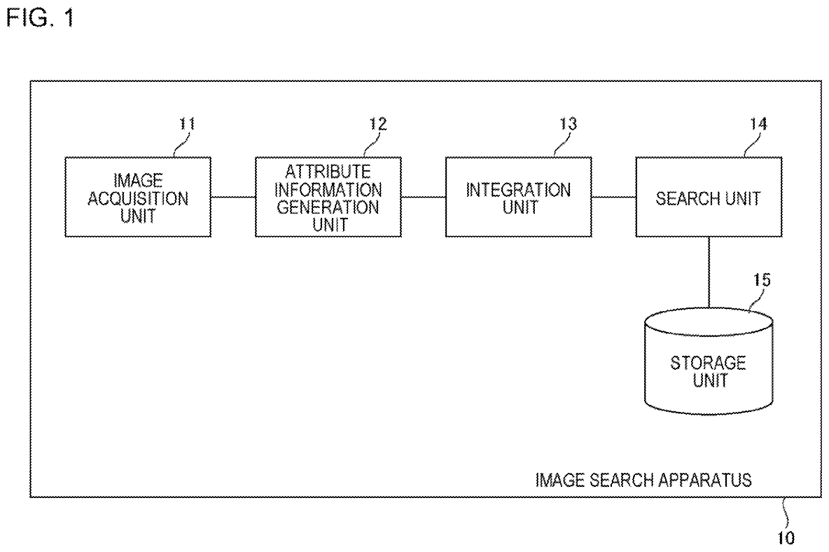

FIG. 1 is a functional block diagram illustrating an overview of an image search apparatus 10 according to a first example embodiment. The image search apparatus 10 includes an image acquisition unit 11, an attribute information generation unit 12, an integration unit 13, a search unit 14, and a storage unit 15. Note that, the image search apparatus 10 may not include the storage unit 15. In this case, an external apparatus configured to be able to communicate with the image search apparatus 10 includes the storage unit 15.

The image acquisition unit 11 acquires a plurality of query images. The attribute information generation unit 12 generates attribute information from each of the plurality of query images. The integration unit 13 generates integrated attribute information by integrating a plurality of pieces of the attribute information generated from each of the plurality of query images. The search unit 14 searches for a target image from a plurality of reference images stored in the storage unit 15 by using the integrated attribute information.

According to the image search apparatus 10 including a configuration as described above, a task of improving accuracy of processing of searching for a desired image from among a plurality of images is achieved.

### Second Example Embodiment

### Overview

An image search apparatus 10 according to a present example embodiment is a more specific example of the image search apparatus 10 according to the first example embodiment.

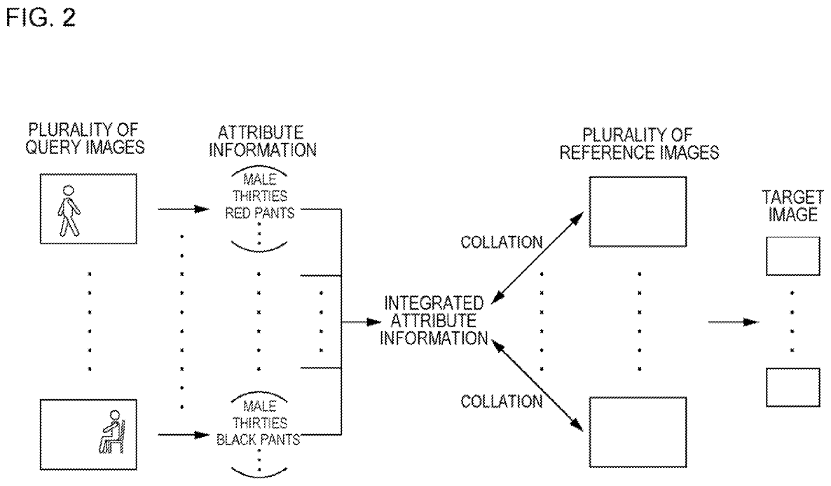

As illustrated in FIG. 2, the image search apparatus 10 acquires “a plurality of” query images. Then, the image search apparatus 10 generates attribute information from each of the plurality of query images, and generates integrated attribute information by integrating a plurality of pieces of the generated attribute information by characteristic processing. Then, the image search apparatus 10 searches for a target image from among a plurality of reference images by collating the integrated attribute information with attribute information of each of the plurality of reference images.

In this way, the image search apparatus 10 according to the present example embodiment generates a query (integrated attribute information) for searching for a desired target image with high accuracy, based on a plurality of query images, and performs an image search by using the query (integrated attribute information). Consequently, it becomes possible to search for a desired target image with high accuracy from among a plurality of reference images without one query image in which all pieces of attribute information of a wide variety become a desired content. Hereinafter, details are described.

### Hardware Configuration

Next, one example of a hardware configuration of the image search apparatus 10 is described. Each functional unit of the image search apparatus 10 is achieved by any combination of hardware and software mainly including a central processing unit (CPU) of any computer, a memory, a program loaded in a memory, a storage unit (capable of storing, in addition to a program stored in advance at a shipping stage of an apparatus, a program downloaded from a storage medium such as a compact disc (CD), a server on the Internet, and the like) such as a hard disk storing the program, and an interface for network connection. Further, it is understood by a person skilled in the art that there are various modification examples as a method and an apparatus for achieving the configuration.

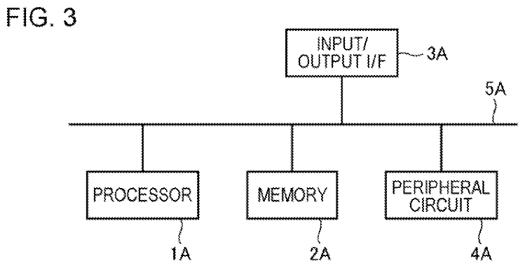

FIG. 3 is a block diagram illustrating a hardware configuration of the image search apparatus 10. As illustrated in FIG. 3, the image search apparatus 10 includes a processor 1A, a memory 2A, an input/output interface 3A, a peripheral circuit 4A, and a bus 5A. The peripheral circuit 4A includes various modules. The image search apparatus 10 may not include the peripheral circuit 4A. Note that, the image search apparatus 10 may be constituted of a plurality of apparatuses that are physically and/or logically separated. In this case, each of the plurality of apparatuses can include the above-described hardware configuration.

The bus 5A is a data transmission path along which the processor 1A, the memory 2A, the peripheral circuit 4A, and the input/output interface 3A mutually transmit and receive data. The processor 1A is, for example, an arithmetic processing apparatus such as a CPU and a graphics processing unit (GPU). The memory 2A is, for example, a memory such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A can issue a command to each module, and perform an arithmetic operation, based on these arithmetic operation results.

### Functional Configuration

Next, a functional configuration of the image search apparatus 10 according to the present example embodiment is described in detail. FIG. 1 illustrates one example of a functional block diagram of the image search apparatus 10. As illustrated in FIG. 1, the image search apparatus 10 includes an image acquisition unit 11, an attribute information generation unit 12, an integration unit 13, a search unit 14, and a storage unit 15. Note that, the image search apparatus 10 may not include the storage unit 15. In this case, an external apparatus configured to be able to communicate with the image search apparatus 10 includes the storage unit 15.

The image acquisition unit 11 acquires a plurality of query images. The image acquisition unit 11 can acquire, for example, a plurality of query images by adopting any of the following acquisition methods 1 to 3.

### —Acquisition Method 1—

A user inputs a plurality of query images (still images) to the image search apparatus 10. The image acquisition unit 11 acquires the plurality of query images input as described above.

A user can input, for example, to the image search apparatus 10, a plurality of images indicating status similar to status indicated by a predetermined target image to be desired to search, as a plurality of query images. In a case where a target image is “an image including a male in his thirties and wearing a red shirt and glasses”, a user can input, to the image search apparatus 10 as a query image, a plurality of images in which at least one attribute becomes a desired content (an image in which attributes as many as possible become a desired content is preferable), such as “an image including a male wearing a red shirt”, “an image including a male wearing a red shirt and glasses”, “an image including a male in his thirties and wearing glasses”, and “an image of a male in his thirties”. Input of an image to the image search apparatus 10 is achieved by utilizing any known technique.

### —Acquisition Method 2—

A user inputs a moving image to the image search apparatus 10. The image acquisition unit 11 acquires, as a plurality of query images, a plurality of frame images from the moving image.

A user can input, for example, to the image search apparatus 10, a plurality of images indicating status similar to status indicated by a predetermined target image to be desired to search, as a plurality of query images. In a case where a target image is “an image including a male in his forties and in a seated pose”, a user can input, to the image search apparatus 10, “a moving image including a male in his forties”, “a moving image including a person in a seated pose”, “a moving image including a male in a seated pose”, and the like. Input of a moving image to the image search apparatus 10 is achieved by utilizing any known technique.

The following examples are conceived as a means for acquiring, as a plurality of query images, a plurality of frame images from a moving image.

For example, the image acquisition unit 11 may set, as a plurality of query images, a plurality of frame images selected from among a plurality of frame images according to a predetermined rule. The predetermined rule is selection at random, selection at every predetermined frame, and the like are exemplified, but the example embodiment is not limited thereto.

As another example, the image acquisition unit 11 may present (example: display on a display) a plurality of frame images selected as described above toward a user, and also accept a user input of selecting a plurality of frame images serving as query images from among the frame images. Then, the image acquisition unit 11 may acquire, as a plurality of query images, a plurality of frame images selected by the user input.

### —Acquisition Method 3—

A user inputs one query image (still image) to the image search apparatus 10. Hereinafter, the one query image input by a user may be referred to as “one input query image”.

A user can input, for example, to the image search apparatus 10, one image indicating status similar to status indicated by a predetermined target image to be desired to search, as one query image. In a case where a target image is “an image including a male in his thirties and wearing a red shirt and glasses”, a user can input, to the image search apparatus 10 as a query image, one image in which at least one attribute becomes a desired content (an image in which attributes as many as possible become a desired content is preferable), such as “an image including a male wearing a red shirt”, “an image including a male wearing a red shirt and glasses”, “an image including a male in his thirties and wearing glasses”, and “an image of a male in his thirties”. Input of an image to the image search apparatus 10 is achieved by utilizing any known technique.

Then, the image acquisition unit 11 searches a database by using the one input query image, as a query. The database may store a reference image to be described in the following, or may store an image different from a reference image. Then, the image acquisition unit 11 acquires, as a query image, one or a plurality of images hit by the search. Specifically, in the example, the image acquisition unit 11 acquires, as a query image, one input query image, and one or a plurality of images hit by the search. A condition for hitting by the above-described search is a design matter, but, for example, a condition that “a degree of similarity is equal to or more than a threshold value”, and the like are exemplified.

As another example, the image acquisition unit 11 may present (example: display on a display) one or a plurality of images hit by the above-described search toward a user, and also accept a user input of selecting an image serving as a query image from among the images. Then, the image acquisition unit 11 may acquire, as query images, an image selected by the user input, and the one input query image.

The attribute information generation unit 12 generates attribute information from each of a plurality of query images acquired by the image acquisition unit 11. The attribute information is generated by analyzing a query image. The attribute information may be generated based on metadata of a query image.

The attribute information includes information on a plurality of items. For example, the attribute information can include attribute information of a person included in a query image. As examples of an item of the attribute information, gender, an age group, a feature value of a face, a feature of clothes, a type of clothes, a hairstyle, presence or absence of a hat/cap, presence or absence of glasses, presence or absence of a mask, a physique, a height, a pose, and the like are exemplified. Further, the attribute information can include attribute information to be extracted from a background included in a query image. As examples of an item of the attribute information, a type of an object (such as a mountain, a tree, a telegraph pole, and a predetermined landmark) being present in a background, a photographing time period (such as a nighttime and a daytime), a photographing place, and the like are exemplified. These pieces of attribute information can be determined by analyzing a query image by a known technique. As one example of the determination, a degree of certainty of each item value is computed for each item by an analysis of a query image. An item value of each item indicates a content achievable by each item. For example, in a case where an item is gender, a male or a female becomes an item value. A computation method of a degree of certainty is not specifically limited, but any known technique can be adopted. Then, the attribute information can be set as information indicating an item value in which a degree of certainty is highest, or an item value in which a degree of certainty is equal to or more than a threshold value, for each item.

Further, the attribute information can include information indicated by metadata of a query image. As examples of an item of the attribute information, a photographing date and time, a photographing place, and the like are exemplified.

The integration unit 13 generates integrated attribute information by integrating a plurality of pieces of attribute information generated from each of a plurality of query images. The search unit 14 searches for a target image from among a plurality of reference images stored in the storage unit 15 by using, as a query, the integrated attribute information generated by the integration unit 13.

The integration unit 13 can be configured to be able to implement one or more of the following integration methods 1 to 6. In description on each of the following integration methods, an example of an image search using integrated attribute information generated by each integration method is described together.

### —Integration Method 1—

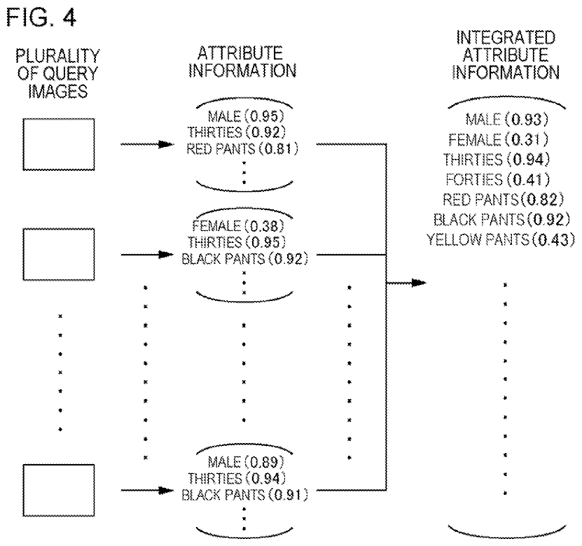

The integration method is described by using FIG. 4. In the example, as illustrated in FIG. 4, a degree of certainty of an item value of each item determined by an image analysis is indicated in attribute information to be generated by the attribute information generation unit 12. In the illustrated example, attribute information generated from the topmost query image indicates that a degree of certainty of “male (gender)” is 0.95, a degree of certainty of “thirties (age group)” is 0.92, and a degree of certainty of “red pants (clothes)” is 0.81.

The integration unit 13 performs processing of grouping attribute information generated from each of a plurality of query images in which item values coincide with each other for each item, and processing of computing a statistical value (example: an average value, a mode value, a median value, a maximum value, a minimum value, and the like) of a degree of certainty of an item value for each group. By the pieces of processing, a combination of an item value, and a statistical value of a degree of certainty of the item value is generated for each group. Then, the integration unit 13 generates a set of the combinations, as integrated attribute information.

The illustrated attribute information becomes a set of combinations of “an item value”, and “a statistical value of a degree of certainty of the item value”. In a case of the illustrated “male (0.93)”, “male” is “an item value”, and “0.93” is “a statistical value of a degree of certainty of the item value”. Integrated attribute information can include all item values included in a plurality of pieces of attribute information generated from a plurality of query images. Then, in the integrated attribute information, a statistical value of a degree of certainty of an item value is associated for the each item value.

Next, one example of an image search in which the integrated attribute information is used as a query is described.

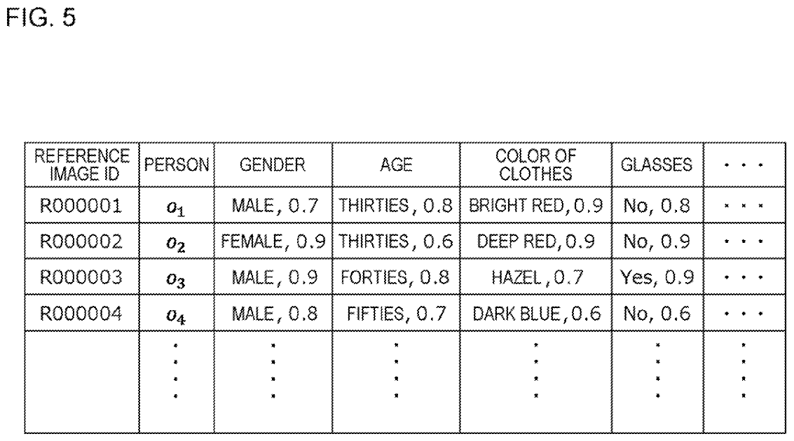

First, as illustrated in FIG. 5, attribute information is generated for each reference image. Then, a degree of certainty of each item value is indicated in the attribute information. In the figure, regarding the item “gender”, “male” and “female” are item values, and a numerical value of 1 or less being indicated on a side of the item value is a degree of certainty. Note that, in the illustrated example, one item value (item value in which a degree of certainty is highest), and a degree of certainty thereof are indicated in association with one item. As another example, a plurality of item values, and a degree of certainty of each of the plurality of item values may be indicated in association with one item. Specifically, in attribute information for each reference image, “male, 0.7”, “female, 0.2”, and the like may be indicated in association with a person o₁ illustrated in FIG. 5.

The search unit 14 searches, as a target image, for a reference image in which a relation between attribute information as illustrated in FIG. 5, and integrated attribute information (query) satisfies a predetermined condition, from among a plurality of reference images.

### Example 1 of Predetermined Condition

The predetermined condition is, for example, “a degree of similarity between the above-described attribute information, and integrated attribute information is equal to or more than a threshold value”. Although there are various methods of computing a degree of similarity, for example, a computation method may be achieved by an arithmetic operation using a predetermined function.

Details on the function are not specifically limited, but, for example, the function may be expressed by the following equation (1).

### [Mathematical 1]

S(o)=Σⱼ₌₁^{m}pⱼ^{q}·pⱼ^{o}·Sim(fⱼ^{q},fⱼ^{o}) equation (1)

pⱼ^{q} is a degree of certainty of a j-th element included in integrated attribute information. In a case of the example of integrated attribute information in FIG. 4, a first element is “male (0.93)”, and a degree of certainty of the element is “0.93”.

pᵢ^{o} is a degree of certainty of an item value of the same item as the above-described “j-th element” included in attribute information of an o-th reference image. When integrated attribute information in FIG. 4 is given, and in a case where j=1, the above-described “j-th element” becomes “male (0.93)” as described above. Therefore, the same item as the above-described “j-th element” becomes “gender”. Thus, a degree of certainty of the item value of the same item as the above-described “j(=1)-th element” included in attribute information of the first reference image (R000001) in the example in FIG. 5 is “0.7”. Further, a degree of certainty of the item value of the same item as the above-described “j(=1)-th element” included in attribute information of the second reference image (R000002) in the example in FIG. 5 is “0.9”.

Sim(fⱼ^{q},fᵢ^{o}) is a degree of similarity between an item value of the j-th element included in integrated attribute information, and an item value of the same item as the above-described “j-th element” included in attribute information of the o-th reference image. The degree of similarity is computed by any method.

### Example 2 of Predetermined Condition

The predetermined condition is defined by using an item value and a degree of certainty included in integrated attribute information. For example, in a case where an item value indicated by integrated attribute information is x₁ to xₙ (where n is an integer of 2 or more), and a degree of certainty of each of the item values is y₁ to yₙ, the predetermined condition is “a degree of certainty of x₁ is z₁ or more, a degree of certainty of x₂ is z₂ or more, and a degree of certainty of xₙ is zₙ or more”. z₁ to zₙ are respectively determined based on y₁ to yₙ. For example, y₁ to yₙ may be respectively set as z₁ to zₙ. In addition, z₁ to zₙ may be computed by a predetermined function in which each of y₁ to yₙ is an input. For example, a value acquired by adding a predetermined value to each of y₁ to yₙ, or a value acquired by subtracting a predetermined value from each of y₁ to yₙ may be set as z₁ to zₙ,

For example, in a case where integrated attribute information is “male (degree of certainty: 0.93), female (degree of certainty: 0.31), thirties (degree of certainty: 0.94), and forties (degree of certainty: 0.41)”, one example of the predetermined condition is “a degree of certainty of a male is 0.93 or more, a degree of certainty of a female is 0.31 or more, a degree of certainty of thirties is 0.94 or more, and a degree of certainty of forties is 0.41 or more”.

Note that, in the above-described predetermined condition, tying n conditions “a degree of certainty of xₘ is zₘ or more (1≤m≤n)” by “AND”, and satisfying all these conditions is set as a condition. As a modification example, satisfying n conditions “a degree of certainty of xₘ is zₘ or more (1≤m≤n)” by a predetermined ratio or more, or a predetermined number or more may be set as a condition.

Further, regarding a condition “a degree of certainty of xₘ is zₘ or more (1≤m≤n)” relating to a same item, at least any thereof may be satisfied. For example, in a case where integrated attribute information is “male (degree of certainty: 0.93), female (degree of certainty: 0.31), thirties (degree of certainty: 0.94), and forties (degree of certainty: 0.41)”, one example of the predetermined condition is “satisfying at least one of a condition in which a degree of certainty of a male is 0.93 or more, and a condition in which a degree of certainty of a female is 0.31 or more, and satisfying at least one of a condition in which a degree of certainty of thirties is 0.94 or more, and a condition in which a degree of certainty of forties is 0.41 or more”.

Note that, the predetermined condition exemplified herein is merely one example, and the example embodiment is not limited to the one exemplified herein.

### —Integration Method 2—

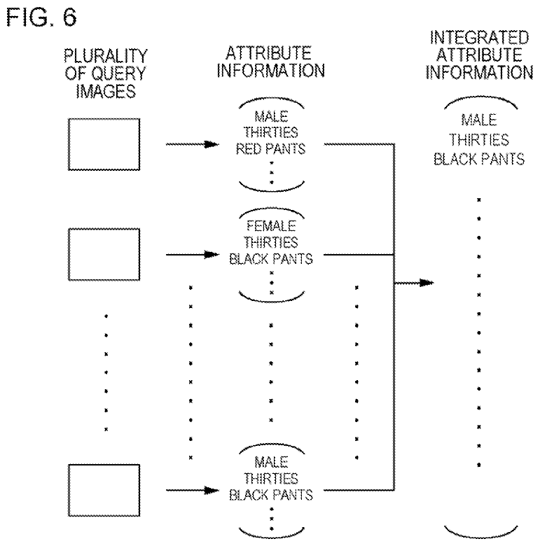

The integration method is described by using FIG. 6. In the example, the integration unit 13 determines an item in which a same item value is achieved for all, a predetermined ratio or more, or a predetermined number or more of a plurality of pieces of attribute information generated from each of a plurality of query images. Specifically, the integration unit 13 determines an item in which a same item value is achieved for all, a predetermined ratio or more, or a predetermined number or more of N pieces of attribute information generated from each of N (where N is an integer of 2 or more) query images. Then, the integration unit 13 generates, as integrated attribute information, a set of item values of the determined item.

For example, in a case where an item value of the item “gender” is “male” in all, a predetermined ratio or more, or a predetermined number or more of N pieces of attribute information generated from each of N (where N is an integer of 2 or more) query images, as illustrated in FIG. 6, the integration unit 13 includes, in integrated attribute information, the item value (male) of the item (gender).

Further, in a case where an item value of the item “age group” is “thirties” in all, a predetermined ratio or more, or a predetermined number or more of N pieces of attribute information generated from each of N (where N is an integer of 2 or more) query images, as illustrated in FIG. 6, the integration unit 13 includes, in integrated attribute information, the item value “thirties” of the item “age group”.

In this way, the integration unit 13 generates, as integrated attribute information, a set of the item values of the determined item.

Next, one example of an image search in which the integrated attribute information is used as a query is described.

First, as illustrated in FIG. 5, attribute information is generated for each reference image. An item value of each item of attribute information of a reference image indicates an item value in which a degree of certainty is highest. Then, the search unit 14 searches, as a target image, for a reference image in which all, a predetermined ratio or more, or a predetermined number or more of a plurality of item values indicated by integrated attribute information are included in attribute information of its own.

### —Integration Method 3—

The integration method is described by using FIG. 6. In the example, the integration unit 13 takes a majority vote for each item, based on a plurality of pieces of attribute information generated from each of a plurality of query images. Then, the integration unit 13 includes, in integrated attribute information, an item value whose number is largest, as an item value of each item.

Specifically, the integration unit 13 performs processing of grouping attribute information generated from each of a plurality of query images in which item values coincide with each other for each item, processing of counting the number of members belonging to a group for each group, and processing of determining a group in which the number of members is largest for each item. Then, the integration unit 13 generates, as integrated attribute information, a set of item values associated with each of groups determined for each item.

For example, in nine pieces of attribute information generated from each of nine query images, in a case where the number of pieces of attribute information in which the item value of the item “gender” is “male” is “8”, and the number of pieces of attribute information in which the item value of the item “gender” is “female” is “1”, as illustrated in FIG. 6, the integration unit 13 includes, in integrated attribute information, “male”, as an item value of the item (gender).

Further, for example, in nine pieces of attribute information generated from each of nine query images, in a case where the number of pieces of attribute information in which the item value of the item “age group” is “thirties” is “5”, the number of pieces of attribute information in which the item value of the item “age group” is “forties” is “3”, and the number of pieces of attribute information in which the item value of the item “age group” is “twenties” is “1”, as illustrated in FIG. 6, the integration unit 13 includes, in integrated attribute information, “thirties”, as an item value of the item (age group).

In this way, the integration unit 13 generates, as integrated attribute information, a set of item values whose number is largest for each item.

One example of the image search in which integrated attribute information in the example is used as a query is the same as the above-described example of the integration method 2.

### —Integration Method 4—

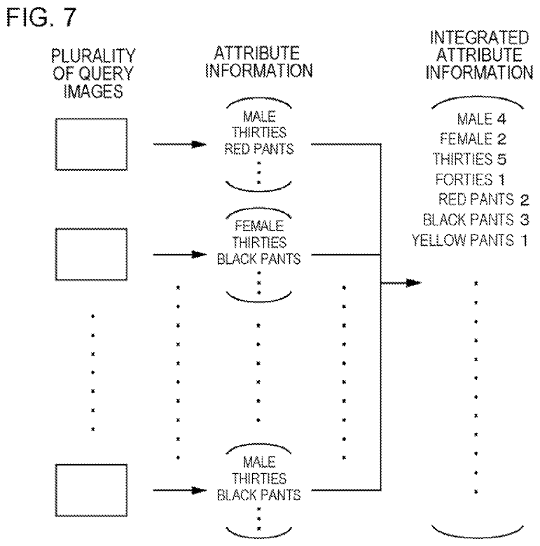

The integration method is described by using FIG. 7. In the example, as illustrated in FIG. 7, the integration unit 13 generates a set of weighted item values, as integrated attribute information. Regarding “male 4” in the illustrated integrated attribute information, “male” is an item value, and “4” is a weight thereof.

The integration unit 13 generates a combination of an item value and a weight for each group by performing processing of grouping attribute information generated from each of a plurality of query images in which item values coincide with each other for each item, and processing of setting a weight for each group. Then, the integration unit 13 generates a set of the combinations, as integrated attribute information.

A weight for each group can be set as a weight depending on the number of members belonging to each group. As the number of members increases, a larger weight is set. For example, the number itself of members may be set as a weight, a weight may be computed by a predetermined function in which the number of members is an input, or a weight may be computed by another method.

Integrated attribute information can include all item values included in a plurality of pieces of attribute information generated from a plurality of query images. Then, a weight is associated for the each item value in the integrated attribute information.

Next, one example of an image search in which the integrated attribute information is used as a query is described.

First, as illustrated in FIG. 5, attribute information is generated for each reference image. Then, the search unit 14 can search for a reference image in which a degree of similarity between attribute information as illustrated in FIG. 5, and integrated attribute information is equal to or more than a threshold value. Although there are various methods of computing a degree of similarity, for example, a computation method may be achieved by an arithmetic operation using a predetermined function. For example, in the above-described equation (1), a product of pⱼ^{q}, pⱼ^{o}, and Sim(fⱼ^{q},fⱼ^{o}) may be multiplied by a value depending on a weight. The larger the weight, the larger the value to multiply.

### —Integration Method 5—

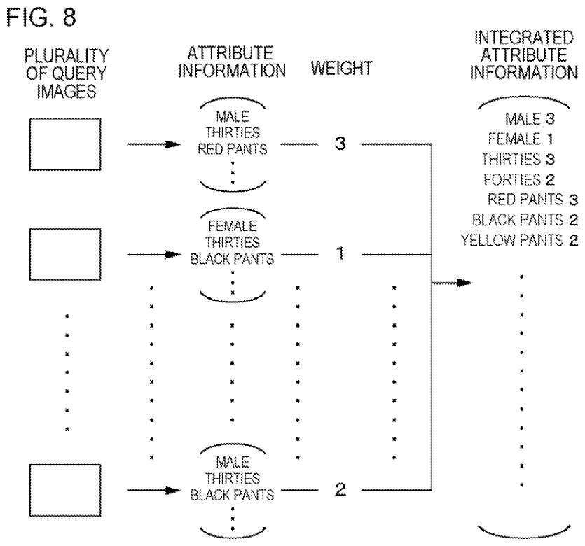

The integration method is described by using FIG. 8. In the example, as illustrated in FIG. 8, a weight is set for each of a plurality of query images in a unit of a query image. For example, the integration unit 13 accepts a user input of setting the weight. Then, the integration unit 13 sets a weight for each query image, based on the user input.

Then, in the example, as illustrated in FIG. 8, the integration unit 13 generates a set of weighted item values, as integrated attribute information. Regarding “male 3” in the illustrated integrated attribute information, “male” is an item value, and “3” is a weight thereof.

The integration unit 13 generates integrated attribute information by applying a weight set for each of a plurality of query images to each of a plurality of pieces of attribute information generated from each of the plurality of query images. In a case where a same item value is included in a plurality of pieces of attribute information, the integration unit 13 may set a greatest weight, as a weight of the item value in integrated attribute information, or may set another statistical value such as an average value, a mode value, a median value, and a minimum value, as a weight of the item value in integrated attribute information.

For example, as illustrated in FIG. 8, in a plurality of pieces of attribute information generated from each of a plurality of query images, in a case where there are a plurality of pieces of attribute information in which the item value of the item “gender” is “male”, a maximum value among weights being associated with the plurality of pieces of attribute information can be included in integrated attribute information, as a weight of the item value (male).

One example of an image search in which integrated attribute information in the example is used as a query is the same as the above-described example of the integration method 4.

### —Integration Method 6—

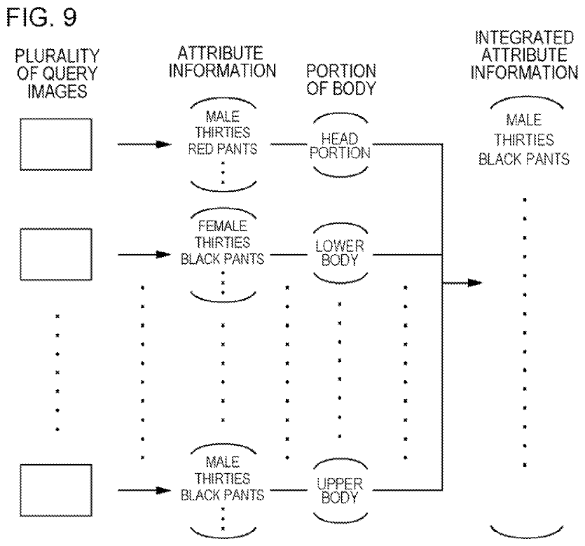

The integration method is described by using FIGS. 9 to 11. In the example, as illustrated in FIG. 9, a portion of a body of a person is specified for each of a plurality of query images in the unit of a query image. For example, the integration unit 13 accepts a user input of performing the specification. Then, the integration unit 13 specifies a portion of a body for each query image, based on the user input.

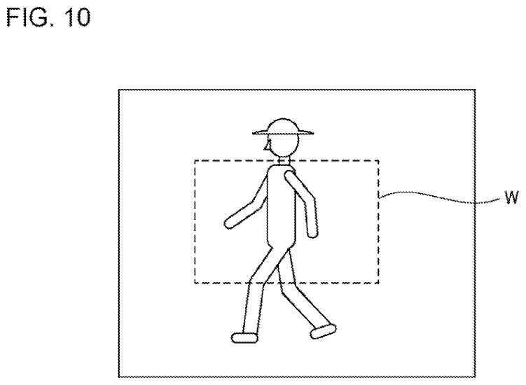

There are various methods of accepting a user input. For example, as illustrated in FIG. 10, the integration unit 13 may accept a user input of specifying a partial area of a query image by a frame W. In this case, a portion of a body being present in the frame W is specified. In addition, the integration unit 13 may accept an input of specifying a portion of a body via a user interface (UI) component capable of selecting a portion from among a plurality of bodies such as “a head portion”, “an upper body”, or “a lower body”.

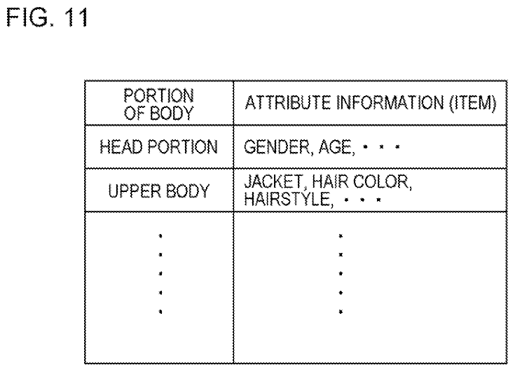

As illustrated in FIG. 11, an item of at least one piece of attribute information is associated in advance with each of portions of a body. As illustrated in FIG. 9, the integration unit 13 extracts, from among a plurality of pieces of attribute information generated from each of a plurality of query images, attribute information relating to portions of a body of a person being different from each other for each query image. Specifically, the integration unit 13 extracts, from attribute information of each query image, information on an item associated with a portion of a body of a person specified by a user. Then, the integration unit 13 generates a set of pieces of the extracted attribute information, as integrated attribute information.

One example of an image search in which integrated attribute information in the example is used as a query is the same as the above-described examples of the integration methods 2 and 3.

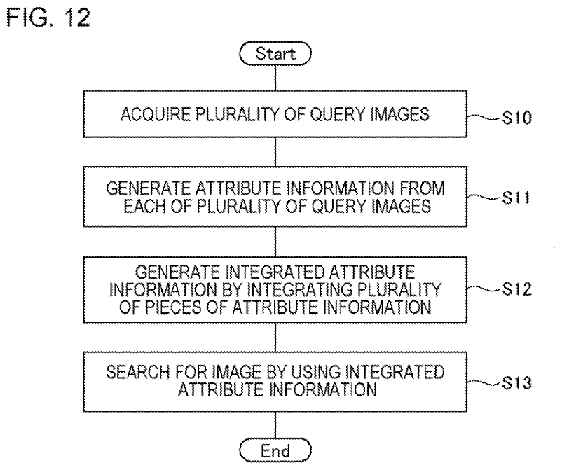

Next, one example of a flow of processing of the image search apparatus 10 is described by using a flowchart in FIG. 12.

When the image search apparatus 10 acquires a plurality of query images (S10), the image search apparatus 10 generates attribute information from each of the plurality of query images (S11). Then, the image search apparatus 10 integrates a plurality of pieces of the attribute information generated from each of the plurality of query images, and generates integrated attribute information (S12). Subsequently, the image search apparatus 10 searches for a target image from among a plurality of reference images by using the integrated attribute information generated in S12, as a query (S13).

Although not illustrated, in S13, the image search apparatus 10 can output a search result. For example, the image search apparatus 10 may output, as a search result, a screen on which a searched target image is displayed as a list. The search result is output via an output apparatus such as a display, a projection apparatus, or a printer.

### Advantageous Effect

The image search apparatus 10 according to the present example embodiment generates a query (integrated attribute information) for searching for a desired target image with high accuracy, based on a plurality of query images, and performs an image search by using the query (integrated attribute information). Consequently, it becomes possible to search for a desired target image with high accuracy from among a plurality of reference images without one query image in which all pieces of attribute information of a wide variety become a desired content.

Further, the image search apparatus 10 can generate a query (integrated attribute information) by using a characteristic integration method as described above. Therefore, it is possible to generate, with high accuracy, a query (integrated attribute information) for searching for a desired target image with high accuracy.

### Third Example Embodiment

Similarly to the first and second example embodiments, an image search apparatus 10 according to a present example embodiment integrates a plurality of pieces of attribute information generated from each of a plurality of query images, and generates integrated attribute information. Further, the image search apparatus 10 according to the present example embodiment is configured to be able to implement a plurality of integration methods, and generates integrated attribute information by using an integration method specified by a user from among the plurality of integration methods. Hereinafter, details are described.

An integration unit 13 integrates a plurality of pieces of attribute information generated from each of a plurality of query images, and generates integrated attribute information. The integration unit 13 is configured to be able to implement a plurality of integration methods. The plurality of integration methods may include any of the integration methods 1 to 6 described in the second example embodiment. Further, the plurality of integration methods may include an integration method other than the integration methods 1 to 6 described in the second example embodiment.

The integration unit 13 accepts a user input of selecting one from among a plurality of integration methods. Then, the integration unit 13 integrates a plurality of pieces of attribute information by the selected integration method, and generates integrated attribute information. Acceptance of a user input of selecting one integration method is achieved by utilizing any known technique.

Other configurations of the image search apparatus 10 according to the present example embodiment are similar to those of the first and second example embodiments.

In the image search apparatus 10 according to the present example embodiment, an advantageous effect similar to that of the first and second example embodiments is achieved. Further, in the image search apparatus 10 according to the present example embodiment, a user can generate integrated attribute information (query) by a desired integration method among a plurality of integration methods. Consequently, integrated attribute information (query) desired by a user can be generated accurately. Then, it becomes possible to search for a desired target image with high accuracy by performing an image search by using the integrated attribute information (query).

### Fourth Example Embodiment

An image search apparatus 10 according to a present example embodiment accepts a user input of specifying attribute information by a means other than an image input. Then, the image search apparatus 10 according to the present example embodiment integrates attribute information generated from a query image, and attribute information specified by the user input, and generates integrated attribute information. Hereinafter, details are described.

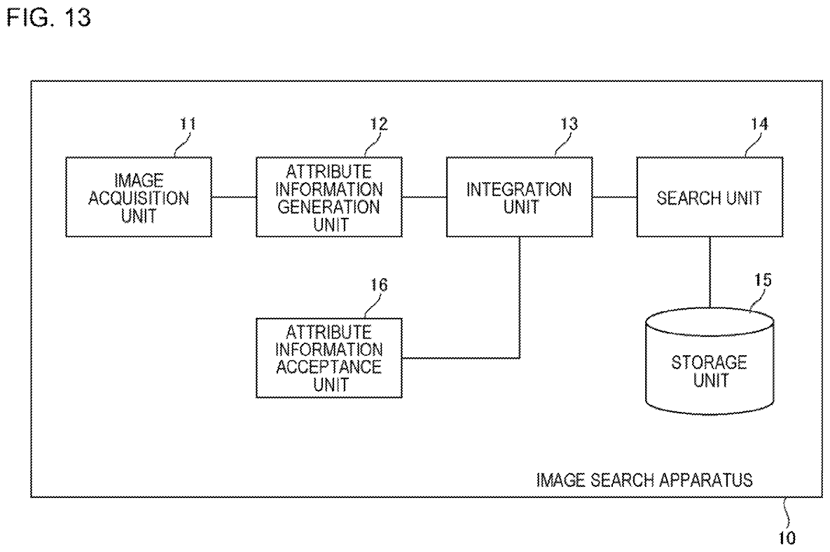

FIG. 13 illustrates one example of a functional block diagram of the image search apparatus 10 according to the present example embodiment. As illustrated in FIG. 13, the image search apparatus 10 includes an image acquisition unit 11, an attribute information generation unit 12, an integration unit 13, a search unit 14, a storage unit 15, and an attribute information acceptance unit 16.

The attribute information acceptance unit 16 accepts a user input of specifying attribute information by a means other than an image input. A user performs an input of specifying an item value of a predetermined item, for example, such as “female, thirties”. In addition, a user may perform an input of specifying an item value of a predetermined item, and a degree of certainty thereof, such as “female (0.72), thirties (0.83)”. The attribute information acceptance unit 16 can accept, for example, a user input as described above via any UI component.

The integration unit 13 integrates attribute information (attribute information generated by the attribute information generation unit 12) generated from each of a plurality of query images, and attribute information (attribute information accepted by the attribute information acceptance unit 16) specified by a user input, and generates integrated attribute information. The integration unit 13 can achieve the integration, for example, by using an integration method described in the second example embodiment.

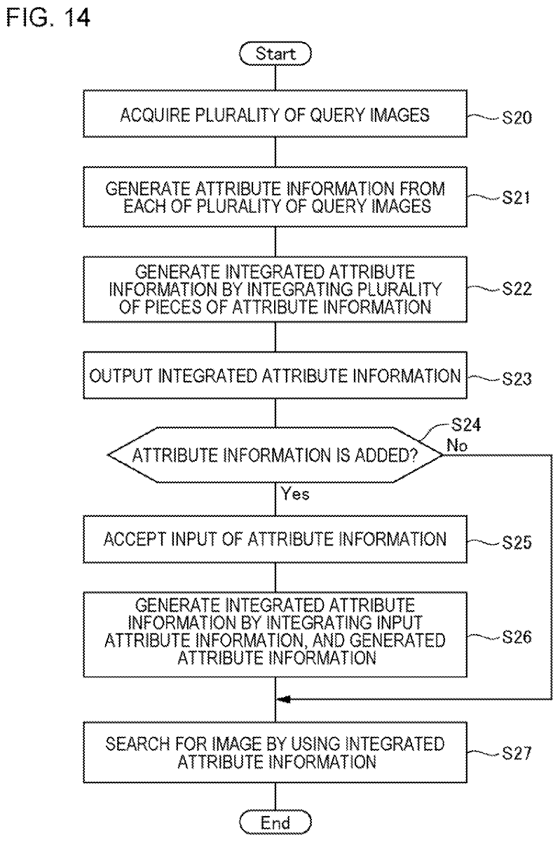

Next, one example of a flow of processing of the image search apparatus 10 is described by using a flowchart in FIG. 14.

When the image search apparatus 10 acquires a plurality of query images (S20), the image search apparatus 10 generates attribute information from each of the plurality of query images (S21). Then, the image search apparatus 10 integrates a plurality of pieces of the attribute information generated from each of the plurality of query images, and generates integrated attribute information (S22). Subsequently, the image search apparatus 10 outputs the integrated attribute information generated in S22 toward a user (S23). For example, the image search apparatus 10 displays, on a display, the integrated attribute information generated in S22.

Thereafter, the image search apparatus 10 accepts, from a user, an input as to whether to add attribute information (S24).

In a case where an instruction to add attribute information is input (Yes in S24), the image search apparatus 10 accepts a user input of specifying attribute information by a means other than an image input (S25). Then, the image search apparatus 10 integrates a plurality of pieces of the attribute information generated in S21, and the attribute information input in S25, and generates integrated attribute information (S26). Subsequently, the image search apparatus searches for a target image from among a plurality of reference images by using the integrated attribute information generated in S26, as a query (S27).

On the other hand, in a case where an instruction to add attribute information is not input in S24 (No in S24), the image search apparatus 10 searches for a target image from among a plurality of reference images by using the integrated attribute information generated in S22, as a query (S27). Outputting the integrated attribute information generated in S26 toward a user (S23), and accepting, from the user, an input as to whether to add attribute information (S24) may be repeated until an instruction to add attribute information is not input.

Although not illustrated, in S27, the image search apparatus 10 can output a search result. For example, the image search apparatus 10 may output, as a search result, a screen on which a searched target image is displayed as a list. The search result is output via an output apparatus such as a display, a projection apparatus, or a printer.

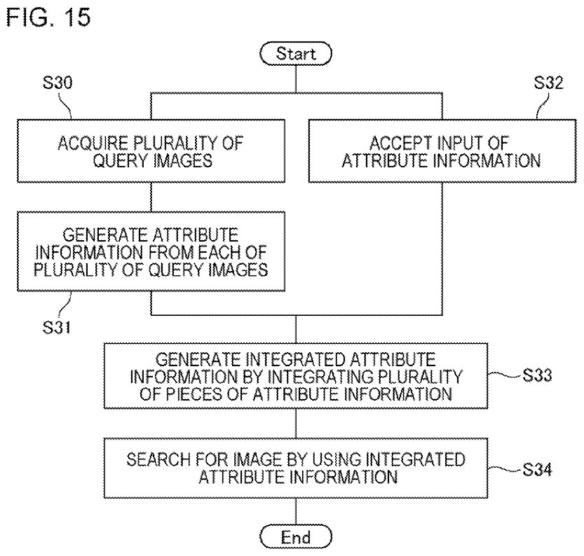

Next, another example of a flow of processing of the image search apparatus 10 is described by using a flowchart in FIG. 15.

When the image search apparatus 10 acquires a plurality of query images (S30), the image search apparatus 10 generates attribute information from each of the plurality of query images (S31). Further, the image search apparatus 10 accepts a user input of specifying attribute information by a means other than an image input (S32). Pieces of processing of S30 and S31, and a piece of processing of S32 may be performed concurrently as illustrated in FIG. 15, or may be performed in any order.

Then, the image search apparatus 10 integrates a plurality of pieces of the attribute information generated in S31, and the attribute information input in S32, and generates integrated attribute information (S33). Subsequently, the image search apparatus 10 searches for a target image from among a plurality of reference images by using the integrated attribute information generated in S33, as a query (S34).

Although not illustrated, in S34, the image search apparatus 10 can output a search result. For example, the image search apparatus 10 may output, as a search result, a screen on which a searched target image is displayed as a list. The search result is output via an output apparatus such as a display, a projection apparatus, or a printer.

Other configurations of the image search apparatus 10 according to the present example embodiment are similar to those of the first to third example embodiments.

In the image search apparatus 10 according to the present example embodiment, an advantageous effect similar to that of the first to third example embodiments is achieved. Further, in the image search apparatus 10 according to the present example embodiment, a user can input attribute information by a means other than an image input, and generate integrated attribute information (query) by using the attribute information as well. Consequently, integrated attribute information (query) desired by a user can be generated accurately. Then, it becomes possible to search for a desired target image with high accuracy by performing an image search by using the integrated attribute information (query).

### Modification Example

An image search apparatus 10 may perform an image search by further using, as a query, attribute information of an item other than the above-described exemplified items. As attribute information of an item other than the above-described exemplified items, a size of an image, a type of a camera, and the like are exemplified, but the present invention is not limited thereto. These pieces of information can be determined, for example, based on metadata of an image.

As described above, while the example embodiments according to the present invention have been described with reference to the drawings, these are exemplifications of the present invention, and various configurations other than the above can also be adopted. Configurations of the above-described example embodiments may be combined with each other, or some of the configurations may be replaced by another configuration. Further, various modifications may be added to a configuration of the above-described example embodiments within a range that does not depart from the gist. Furthermore, a configuration and processing disclosed in the above-described example embodiments and modification examples may be combined with each other.

Further, in a plurality of flowcharts used in the above description, a plurality of processes (pieces of processing) are described in order, but an order of execution of processes to be performed in each example embodiment is not limited to the order of description. In each example embodiment, the illustrated order of processes can be changed within a range that does not adversely affect a content. Further, the above-described example embodiments can be combined, as far as contents do not conflict with each other.

A part or all of the above-described example embodiments may also be described as the following supplementary notes, but is not limited to the following.
1. An image search apparatus including:
   an image acquisition unit that acquires a plurality of query images;
   an attribute information generation unit that generates attribute information from each of a plurality of the query images;
   an integration unit that generates integrated attribute information by integrating a plurality of pieces of the attribute information generated from each of a plurality of the query images; and
   a search unit that searches for a target image from among a plurality of reference images by using the integrated attribute information.
2. The image search apparatus according to supplementary note 1, wherein
   the integration unit
      accepts a user input of selecting one from among a plurality of integration methods, and
      integrates a plurality of pieces of the attribute information by the selected integration method.
3. The image search apparatus according to supplementary note 1 or 2, further including
   an attribute information acceptance unit that accepts a user input of specifying the attribute information, wherein
   the integration unit integrates the attribute information generated from each of a plurality of the query images, and the attribute information specified by the user input.
4. The image search apparatus according to any of supplementary notes 1 to 3, wherein
   the attribute information includes information determined by analyzing the query image.
5. The image search apparatus according to any of supplementary notes 1 to 4, wherein
   the attribute information includes information on a plurality of items, and
   the integration unit
      generates a combination of an item value of the item and a statistical value of a degree of certainty of the item value for each group by performing processing of grouping the attribute information generated from each of a plurality of the query images in which the item values coincide with each other for the each item, and processing of computing a statistical value of a degree of certainty of the item value for the each group, and
      generates a set of the combinations, as the integrated attribute information.
6. The image search apparatus according to any of supplementary notes 1 to 4, wherein
   the attribute information includes information on a plurality of items, and
   the integration unit
      determines the item in which a same item value is achieved for all, a predetermined ratio or more, or a predetermined number or more of a plurality of pieces of the attribute information generated from each of a plurality of the query images, and
      generates a set of the item values of the determined item, as the integrated attribute information.
7. The image search apparatus according to any of supplementary notes 1 to 4, wherein
   the attribute information includes information on a plurality of items, and
   the integration unit
      generates a combination of an item value of the item and a weight for each group by performing processing of grouping the attribute information generated from each of a plurality of the query images in which the item values coincide with each other for the each item, and processing of setting the weight depending on a number of members belonging to the group for the each group, and
      generates a set of the combinations, as the integrated attribute information.
8. The image search apparatus according to any of supplementary notes 1 to 4, wherein
   the attribute information includes information on a plurality of items, and
   the integration unit
      performs processing of grouping the attribute information generated from each of a plurality of the query images in which item values coincide with each other for the each item, processing of counting a number of members belonging to the group for the each group, and processing of determining the group in which the number of the members is largest for the each item, and
      generates a set of the item values of the item associated with each of the groups determined for the each item, as the integrated attribute information.
9. The image search apparatus according to any of supplementary notes 1 to 4, wherein
   the integration unit
      accepts a user input of setting a weight for each of a plurality of the query images in a unit of the query image, and
      generates the integrated attribute information by applying the weight set for each of a plurality of the query images to each of a plurality of pieces of the attribute information generated from each of a plurality of the query images.
10. The image search apparatus according to any of supplementary notes 1 to 4, wherein
   the integration unit
      extracts, from among a plurality of pieces of attribute information generated from each of a plurality of the query images, the attribute information relating to portions of a body of a person being different from each other for the each query image, and
      generates a set of the extracted pieces of attribute information, as the integrated attribute information.
11. An image search method including,
   by one or more computers:
   acquiring a plurality of query images;
   generating attribute information from each of a plurality of the query images;
   generating integrated attribute information by integrating a plurality of pieces of the attribute information generated from each of a plurality of the query images; and
   searching a for target image from among a plurality of reference images by using the integrated attribute information.
12. A program causing a computer to function as:
   an image acquisition unit that acquires a plurality of query images;
   an attribute information generation unit that generates attribute information from each of a plurality of the query images;
   an integration unit that generates integrated attribute information by integrating a plurality of pieces of the attribute information generated from each of a plurality of the query images; and
   a search unit that searches for a target image from among a plurality of reference images by using the integrated attribute information.
10 Image search apparatus
11 Image acquisition unit
12 Attribute information generation unit
13 Integration unit
14 Search unit
15 Storage unit
16 Attribute information acceptance unit
1A Processor
2A Memory
3A Input/output I/F
4A Peripheral circuit
5A Bus

1. An image search apparatus comprising:
at least one memory configured to store one or more instructions; and
at least one processor configured to execute the one or more instructions to:
acquire a plurality of query images;
generate attribute information from each of a plurality of the query images;
generate integrated attribute information by integrating a plurality of pieces of the attribute information generated from each of a plurality of the query images; and
search for a target image from among a plurality of reference images by using the integrated attribute information.

2. The image search apparatus according to claim 1, wherein
the processor is further configured to execute the one or more instructions to
accept a user input of selecting one from among a plurality of integration methods, and
integrate a plurality of pieces of the attribute information by the selected integration method.

3. The image search apparatus according to claim 1, wherein
the processor is further configured to execute the one or more instructions to
accept a user input of specifying the attribute information, and
integrate the attribute information generated from each of a plurality of the query images, and the attribute information specified by the user input.

4. The image search apparatus according to claim 1, wherein
the attribute information includes information determined by analyzing the query image.

5. The image search apparatus according to claim 4, wherein
the attribute information includes information on a plurality of items, and
the processor is further configured to execute the one or more instructions to
generate a combination of an item value of the item and a statistical value of a degree of certainty of the item value for each group by performing processing of grouping the attribute information generated from each of a plurality of the query images in which the item values coincide with each other for the each item, and processing of computing a statistical value of a degree of certainty of the item value for the each group, and
generate a set of the combinations, as the integrated attribute information.

6. The image search apparatus according to claim 4, wherein
the attribute information includes information on a plurality of items, and
the processor is further configured to execute the one or more instructions to
determine the item in which a same item value is achieved for all, a predetermined ratio or more, or a predetermined number or more of a plurality of pieces of the attribute information generated from each of a plurality of the query images, and
generate a set of the item values of the determined item, as the integrated attribute information.

7. The image search apparatus according to claim 4, wherein
the attribute information includes information on a plurality of items, and
the processor is further configured to execute the one or more instructions to
generate a combination of an item value of the item and a weight for each group by performing processing of grouping the attribute information generated from each of a plurality of the query images in which the item values coincide with each other for the each item, and processing of setting the weight depending on a number of members belonging to the group for the each group, and
generate a set of the combinations, as the integrated attribute information.

8. The image search apparatus according to claim 4, wherein
the attribute information includes information on a plurality of items, and
the processor is further configured to execute the one or more instructions to
perform processing of grouping the attribute information generated from each of a plurality of the query images in which item values coincide with each other for the each item, processing of counting a number of members belonging to the group for the each group, and processing of determining the group in which the number of the members is largest for the each item, and
generate a set of the item values of the item associated with each of the groups determined for the each item, as the integrated attribute information.

9. The image search apparatus according to claim 4, wherein
the processor is further configured to execute the one or more instructions to
accept a user input of setting a weight for each of a plurality of the query images in a unit of the query image, and
generate the integrated attribute information by applying the weight set for each of a plurality of the query images to each of a plurality of pieces of the attribute information generated from each of a plurality of the query images.

10. The image search apparatus according to claim 4, wherein
the processor is further configured to execute the one or more instructions to
extract, from among a plurality of pieces of attribute information generated from each of a plurality of the query images, the attribute information relating to portions of a body of a person being different from each other for the each query image, and
generate a set of the extracted pieces of attribute information, as the integrated attribute information.

11. An image search method comprising,
by one or more computers:
acquiring a plurality of query images;
generating attribute information from each of a plurality of the query images;
generating integrated attribute information by integrating a plurality of pieces of the attribute information generated from each of a plurality of the query images; and
searching for a target image from among a plurality of reference images by using the integrated attribute information.

12. A non-transitory storage medium storing a program causing a computer to:
acquire a plurality of query images;
generate attribute information from each of a plurality of the query images;
generate integrated attribute information by integrating a plurality of pieces of the attribute information generated from each of a plurality of the query images; and
search for a target image from among a plurality of reference images by using the integrated attribute information.
